(19) United States
(12) Patent Application Publication
(10) Pub. No.: US 2005/0134239 A1
(43) Pub. Date: Jun. 23, 2005

(54) Multiple input redundant power system

(76) Inventors: Shaun Lee Harris, McKinney, TX (US); Steven A. Belson, Plano, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/743,636

(22) Filed: Dec. 22, 2003

(51) Int. Cl. G05F 1/70

(52) U.S. Cl. 323/210

(57) ABSTRACT

A multiple-input redundant power system accepts both AC and DC power inputs. Redundancy is further provided by the use of converters for the AC input, and converters for the DC input. An output distribution element provides for simple combining of converter outputs, and for more complex load sharing and load control arrangements. Advantages accruing from the AC/DC input approach are savings in facility infrastructure, since existing power sources can be utilized, and high availability and reliability in accordance with certain embodiments. The approach has many applications in computing and telecommunications.

### FIELD OF THE INVENTION

This invention relates generally to the field of power distribution systems. More particularly, this invention relates to power distribution systems that provide redundancy against input power failure.

### BACKGROUND

The need to interface between power sources and loads to be powered has always been basic to applied electricity. The most common power sources in use are AC and DC. Many equipments are designed to operate from one or the other, but other equipment is designed to operate from a plurality of power sources, primarily to provide protection against power source failure.

This use of dual power sources is used in the art for systems which must provide reliable operation for extended periods of time. Examples can be found in space flight applications, military systems, and central telecommunications exchanges.

Turning now to FIG. 1, there is shown an example of a prior art configuration in which power to equipments may be supplied by multiple AC power sources. AC source 120 is routed to the first AC input AC1 of connected equipments. AC source 125 is routed to the second AC input AC2 of connected equipments. Connected equipments 105, 110, . . . 115 may be similar or dissimilar equipments depending on user requirements. It is usual that each equipment connected to AC1 and AC2 have switchover capability should one power source fail.

Turning now to FIG. 2, there is shown an example of a prior art configuration in which power to equipment may be supplied by multiple DC power sources. DC source 220 is routed to a first DC input DC1 of connected equipments. DC source 225 is routed to the second DC input DC2 of connected equipments. Connected equipments 205, 210, . . . 215 may be similar or dissimilar equipments depending on user requirements. It is usual that each equipment connected to DC1 and DC2 have switchover capability should one power source fail.

Multiple AC power sources are probably most common, examples being the use of AC with backup UPS and enterprise servers designed for high availability and reliability. Multiple DC power sources are found in telecommunications centers and military applications. By comparison AC-DC power source operation is rare.

In the computer and telecommunications industry most sites have access to both AC power and to −48V DC power. If an extended reliability system is installed, an additional AC (or DC) power system may have to be installed. An example of this would be an enterprise server that requires multiple AC power inputs for redundancy.

### BRIEF SUMMARY

The present invention relates generally to dual or multiple power source equipments.

In accordance with certain embodiments, an equipment operable to receive and operate on both AC and DC input power is described. It comprises of an AC distribution system which receives and distributes AC input power, a DC distribution system which receives and distributes DC input power, one or more AC/DC converters which receive AC input power from the AC distribution system and produce one or more DC outputs, one or more DC/DC converters operable to receive DC input power from the DC distribution system and to produce one or more DC outputs, and an output combining element operable to couple one or more converter outputs to one or more loads.

In accordance with certain other embodiments, a method of operating with dual or multiple input power sources, comprising converting AC input power received by an equipment to one or more AC converted voltages, converting DC input power received by the equipment to one or more second DC converted voltages, and combining the one or more first DC converted voltages and the one or more second DC converted voltages to derive one or more DC equipment voltages.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is an exemplary illustration of a standard AC-AC application according to the prior art.

FIG. 2 is an exemplary illustration of a standard DC-DC application according to the prior art.

FIG. 3 is an exemplary illustration of an AC-DC application for a system in accordance with certain embodiments of the present invention.

FIG. 4 is an exemplary illustration of the input power section of equipment designed for AC-DC in accordance with certain embodiments of the present invention.

FIG. 5 is a further exemplary illustration of an AC-DC application for a system in accordance with certain embodiments of the present invention.

FIG. 6 is an exemplary illustration of a system utilizing equipments powered by AC/DC sources in accordance with certain embodiments of the present invention.

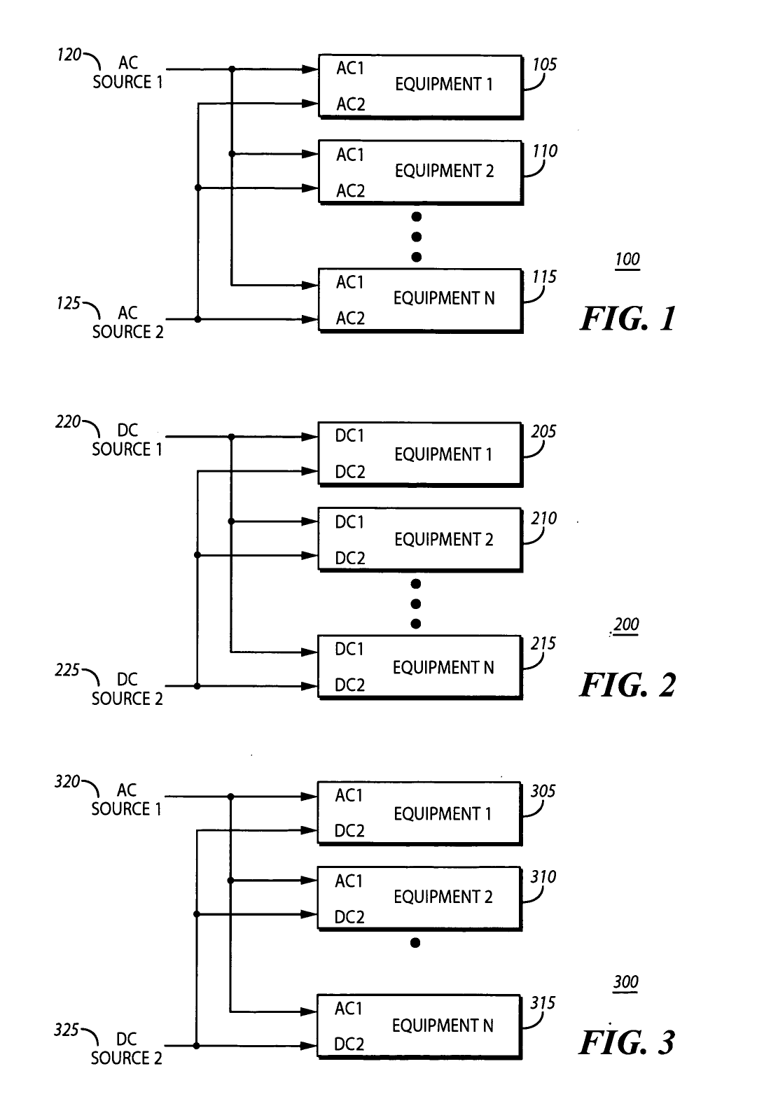

### DETAILED DESCRIPTION

The present invention relates generally to multiple power source equipments, systems, and methods of using thereof. Objects, advantages and features of the invention will become apparent to those skilled in the art upon consideration of the following detailed description of the invention.

A method and structure for achieving power source redundancy is presented in accordance with certain embodiments of the present invention. This is a feature of the present invention which allows AC-DC equipments to be utilized, thereby saving additional infrastructure costs and time.

A method and structure for designing the input power section of AC-DC powered equipment is presented in accordance with certain other embodiments of the present invention. This is a feature of the present invention, allowing input power sections similar to both AC-AC and DC-DC equipments to be combined.

A method and structure for extending the power input sections to include load-sharing converters in accordance with certain embodiments of the present invention. This is a feature of the present invention, and allows sophisticated power conversions to accept AC-DC input power.

Many variations, equivalents and permutations of these illustrative exemplary embodiments of the invention will occur to those skilled in the art upon consideration of the description that follows. The particular examples above should not be considered to define the scope of the invention. For example, a UPS may be utilized either in place of or as an adjunct to AC power. Another example of a variation which does not depart from the spirit of the invention would be placing the AC-DC powered equipment in systems containing other equipment powered differently, such as AC, DC, AC-AC, and DC-DC. A further example would be the use of intelligent power switching in systems as a way to control power changeover timing.

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

For purposes of this document, the exact mechanical and electrical parameters of equipments are unimportant to an understanding of the invention, and many different types of electrical and mechanical components may be utilized without departing from the spirit of the invention. An example is that the required electrical capacity of converters will depend upon the application at hand and may vary between otherwise similar equipments in the same system. This document uses generalized descriptions by way of example only. Many variations for these constituent items are possible without departing from the spirit and scope of the invention.

FIG. 3 is an illustration of a system implementation for AC and DC multiple power sources in accordance with certain embodiments of the present invention. An AC source 320 and a DC source 325 are routed to the AC and DC inputs respectively of system equipments 305, 310, . . . 315. The AC source may be in general of any voltage range, be single phase or 3-phase, and of any number of wires. In general the AC source specifications are determined by system requirements. Typical AC characteristics are single-phase, 3-wire (Delta) or 4-wire (Wye) three phase, with any of these single or three phase configurations having a safety ground, 115/220 VAC and 240 to 480 VAC, by way of example and not limitation. Note that utilizing an existing AC power source may negate the need to increase infrastructure by adding an additional DC power system for independent power.

The present invention envisions diverse AC sources such as substation feeds, inverters, motor-generator sets, and uninterruptible power systems, without departing from the spirit and scope of the invention. In addition the AC source may consist of a multiplicity of AC sources, such that (not shown) a first equipment may be connected to one source and a second equipment connected to the same or a different AC source. It is also clear that the electrical characteristics of system equipments 305 . . . 315 are operationally compatible with the selected AC source(s).

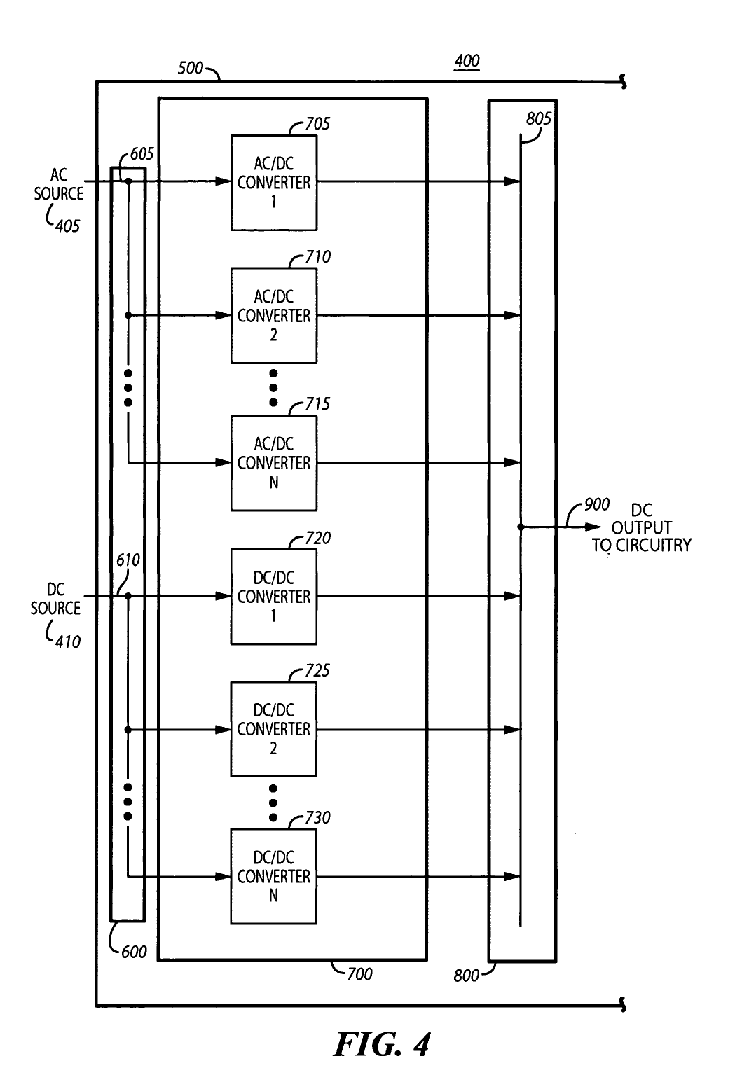

FIG.4 is an exemplary illustration of the input power section of equipment designed for AC-DC in accordance with certain embodiments of the present invention. Equipment 500 may be any one of the 305, 310 . . . 315 equipments, wherein the power conversion section is depicted as power distribution block 600, converter block 700, and DC output block 800. Output block 800 may comprise active or passive circuitry, based upon system requirements. Output block 800 may include communications with one or more processors internal or external to the output block.

AC source 405 is routed to power distribution block 600. Power distribution block 600 distributes AC source 405 to the AC power inputs of AC/DC converters 705, 710 . . . 715. This is illustrated by AC distribution path 605. The number of AC/DC converters 705, 710 . . . 715 needed depends on the internal design requirements of equipment 500. Conditioning to include filtering, fusing, step-up, step-down, and regulation of AC source 405 may be utilized internal or external to equipment 500 without departing from the scope of the invention.

DC source 410 is routed to power distribution block 600. Power distribution block 600 distributes DC source 405 to the DC power inputs of DC/DC converters 720, 725 . . . 730. This is illustrated by DC distribution path 610. The number of DC/DC converters 720, 725 . . . 730 depends on the internal design requirements of equipment 500. Conditioning to include filtering, fusing, and regulation of DC source 410 may be utilized internal or external to equipment 500 without departing from the scope of the invention.

The DC outputs of AC/DC converters 705, 710 . . . 715 and DC/DC converters 720, 725 . . . 730 are combined by DC distribution element 805. DC distribution 805 may consist of a simple diode OR'ing arrangement (diode combining); it may consist of an active combining arrangement (not shown); or it may consist of a feedback arrangement with individual converters for load management and control with or without internal or external processor control. Such variations are within the scope of the present invention, and other methods of integrating the converters with each other and with the output distribution for power control purposes are allowable without departing from the spirit of the invention.

The output of DC distribution 805 is final DC output 900. The value of DC output 900 will be determined by system requirements internal to equipment 500. By way of example, a common requirement for DC output 900 is +48 VDC for enterprise servers and other types of computing and telecom equipment.

It is a feature consistent with certain embodiments of the present invention that the AC input converter section, consisting of AC/DC converters 705, 710 . . . 715, may employ any method of redundancy to achieve higher reliability for equipment 500.

It is a further feature consistent with certain embodiments of the present invention that the DC input converter section, consisting of DC/DC converters 720, 725 . . . 730, may employ any method of redundancy to achieve higher reliability for equipment 500.

It is a further feature consistent with certain embodiments of the present invention that both the AC input converter section, consisting of AC/DC converters 705, 710 . . . 715, and the DC input converter section, consisting of DC/DC converters 720, 725 . . . 730, may employ any method of separate or joint redundancy to achieve higher reliability for equipment 500. Examples of such redundancy would be load sharing between converters, and standby hot converters (N+1 approach).

It is also an advantage consistent with certain embodiments of the present invention that DC source 410, which commonly exists in, for example, telecommunications facilities, may be utilized in lieu of installing facility infrastructure necessary to provide a secondary AC input to achieve higher reliability of the overall system. It is another advantage consistent with certain embodiments of the present invention that AC source 405, which commonly exists in facilities, may be utilized in lieu of installing facility infrastructure necessary to provide a secondary DC input to achieve higher reliability of the overall system. Moreover, in certain embodiments it is a further advantage of the present invention that a tightly regulated DC output may be obtained with the high reliability operation from both AC and DC, as described above.

It is a characteristic that consistent with certain embodiments a power system is described which is inline and achieves the intent of the UPTime Institute Certification guideline for High Availability systems.

An advantage consistent with certain embodiments of the present invention is that, within a facility system, the AC and DC power sources applied to any particular equipment may be of different origins from those applied to other equipments in the system. This is of benefit if different sources are limited in power or located in different facility areas.

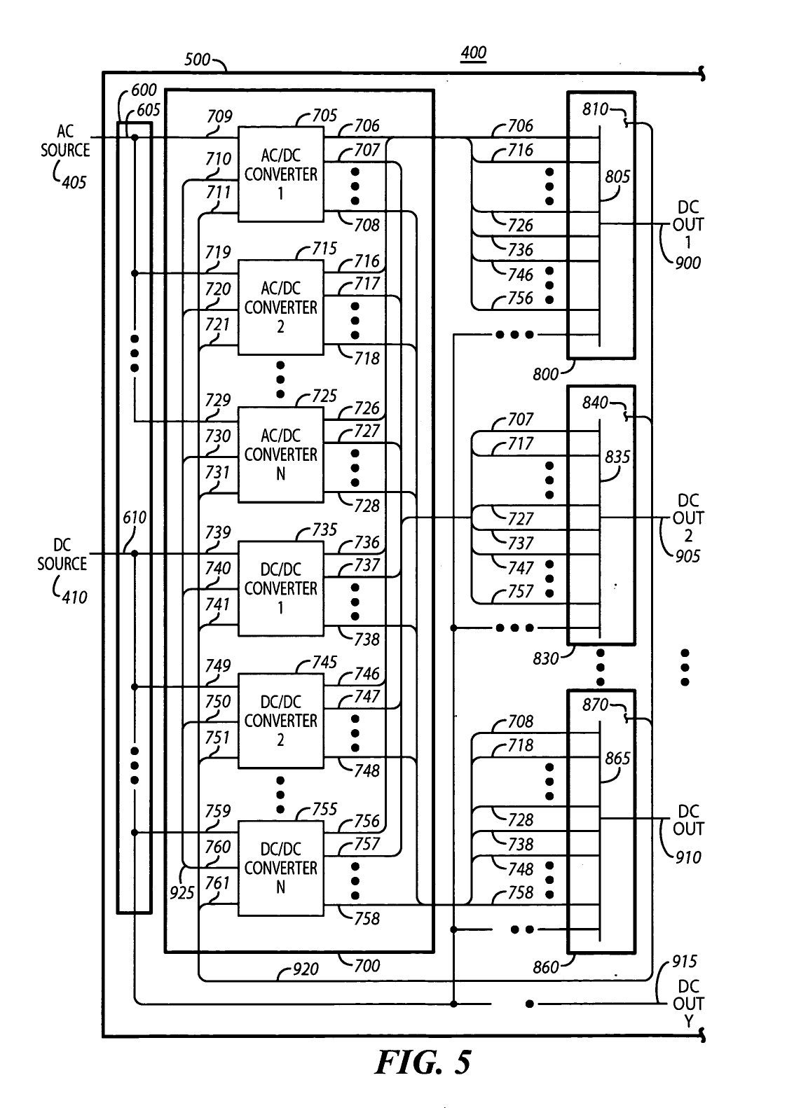

FIG.5 is an exemplary illustration 400 of the input power section of equipment designed for AC-DC in accordance with certain embodiments of the present invention. In this system, equipment 500 may be any one of the 305, 310 . . . 315 equipments, wherein the power conversion section is depicted as power distribution block 600, converter block 700, and DC output blocks 800, 830 . . . 860. Output blocks 800, 830 . . . 860 may comprise active or passive circuitry depending on system requirements. Output blocks 800, 830 . . . 860 may include communications with one or more processors internal or external to the output blocks.

AC source 405 is routed to power distribution block 600. Power distribution block 600 distributes AC source 405 to the AC power inputs of AC/DC converters 705, 715 . . . 725. This is illustrated by AC distribution path 605 which routes AC source 405 to AC/DC converter inputs 709, 719, and 729. The number of AC/DC converters 705, 710 . . . 715 needed depends on the internal design requirements of equipment 500. Conditioning to include filtering, fusing, step-up, step-down, and regulation of AC source 405 may be utilized internal or external to equipment 500 without departing from the spirit and scope of the invention.

DC source 410 is routed to power distribution block 600. Power distribution block 600 distributes DC source 405 to the DC power inputs of DC/DC converters 735, 745 . . . 755. This is illustrated by DC distribution path 610 which routes DC source 410 to DC/DC converter inputs 739, 749, and 759. The number of DC/DC converters 735, 745 . . . 755 depends on the internal design requirements of equipment 500. Conditioning to include filtering, fusing, and regulation of DC source 410 may be utilized internal or external to equipment 500 without departing from the spirit and scope of the invention.

The DC outputs of AC/DC converters 705, 715 . . . 725 and DC/DC converters 735, 745 . . . 755 are combined by DC distribution elements 805, 835, and 865. DC distribution elements 805, 835, and 865 may consist of a simple diode OR'ing arrangements (diode combining), active combining arrangements (not shown), or it may consist of feedback arrangements between individual converters for load management and control, with or without internal or external processor control to the converters. Connections between converters are shown by the interconnection of ports 710, 720 . . . 730 and 740, 750 . . . 760. Any combination of these ports may be utilized. Details of signal flow formats between ports will depend on system requirements. Feedback for load management and control may also be implemented from the DC outputs back to the converters. Voltage detectors/monitors 810, 840, and 870 serve to relay information relative to the output powers 900, 905 . . . 910 to the converters, via ports 711, 721 . . . 731 and 741, 751 . . . 761. Details of signal flow formats between ports and voltage detectors/monitors depends on system requirements. Such variations are within the spirit and scope of the present invention, and other methods of integrating the converters with each other and with the output distribution for power control purposes are allowable without departing from the spirit and scope of the invention.

Each converter may be capable of multiple outputs. Such outputs may provide a multiplicity of voltages, or supplemental current capability. AC/DC converter 705 may have multiple outputs 706, 707 . . . 708. AC/DC converter 715 may have multiple outputs 716, 717 . . . 718. AC/DC converter 725 may have multiple outputs 726, 727 . . . 728. DC/DC converter 735 may have multiple outputs 736, 737 . . . 738. DC/DC converter 745 may have multiple outputs 746, 747 . . . 748. DC/DC converter 755 may have multiple outputs 756, 757 . . . 758. For example, multiple outputs may consist of +5 VDC, −12 VDC and +12 VDC, and single outputs may be +5 VDC or −24 VDC. Each converter may have multiple or single outputs. Each converter may be the same as or different from any other converter, in terms of its voltage outputs.

The multiplicity of voltage outputs available are routed to DC output blocks 800, 830 . . . 860. These output blocks serve to combine similar voltages into a single output. Output block 800 receives converter outputs 706, 716 . . . 726 and 736, 746 . . .756 as inputs. These inputs are combined by DC distribution element 805 to provide output power 900. Output block 830 receives converter outputs 707, 717 . . . 727 and 737, 747 . . . 757 as inputs. These inputs are combined by DC distribution element 835 to provide output power 905. Output block 860 receives converter outputs 708, 718 . . . 726 and 738, 748 . . . 758 as inputs. These inputs are combined by DC distribution element 865 to provide output power 910.

It is a feature consistent with certain embodiments of the present invention that any number of converters may contribute to a specific output voltage, and there may be any number of specific output voltages. For example, the outputs may be +5, +12, −12, +15, −24 and +3.3 VDC, wherein 2 converters may contribute to +5, 4 converters may contribute to +12, 5 converters may contribute to −12, 2 converters may contribute to −24, and 3 converters may contribute to +3.3 VDC. The control of each output voltage may be accomplished within a given converter, by a combination of converters sharing feedback, by feedback from the output back to one or more converters, or any combination thereof. Thus, in certain embodiments an advantage is gained with respect to loss of power, either by loss of source power or converter failure, because multiple power paths can exist for a given output power. Load sharing and partitioning between active converters is achievable, depending on system requirements. DC source 410 is also routed to output blocks 800, 830 . . . 860 in the event that output power 900, 905 . . . 910 is close in voltage to DC source 410 such that the DC source may be substituted as a particular power output should the normally utilized converters fail.

The value of the DC outputs will be determined by system requirements internal to equipment 500. By way of example and not limitation, a common requirement for a DC power output is +48 VDC for enterprise servers and other types of computing and telecom equipment.

It is a feature consistent with certain embodiments of the present invention that the AC input converter section, consisting of AC/DC converters 705, 715 . . . 725, may employ any method of redundancy to achieve higher reliability for equipment 500.

It is a further feature consistent with certain embodiments of the present invention that the DC input converter section, consisting of DC/DC converters 735, 745 . . . 755, may employ any method of redundancy to achieve higher reliability for equipment 500.

It is a further feature consistent with certain embodiments of the present invention that both the AC input converter section, consisting of AC/DC converters 705, 715 . . . 725, and the DC input converter section, consisting of DC/DC converters 735, 745 . . . 755, may employ any method of separate or joint redundancy to achieve higher reliability for equipment 500.

DC source 410, which commonly exists in, for example, telecommunications facilities, may be utilized in lieu of installing facility infrastructure necessary to provide a secondary AC input to achieve higher reliability of the overall system in certain embodiments. AC source 405, which commonly exists in facilities, may be utilized in lieu of installing facility infrastructure necessary to provide a secondary DC input to achieve higher reliability of the overall system in certain embodiments. A tightly regulated DC output may be obtained with high reliability operation from both AC and DC power inputs, as described above.

It is a characteristic of the present invention that a power system is described which is inline and achieves the intent of the UPTime Institute Certification guideline for High Availability systems.

Consistent with certain embodiments, within a facility system the AC and DC power sources applied to any particular equipment may be of different origins from those applied to other equipments in the system. This is of benefit if different sources are limited in power or located in different facility areas.

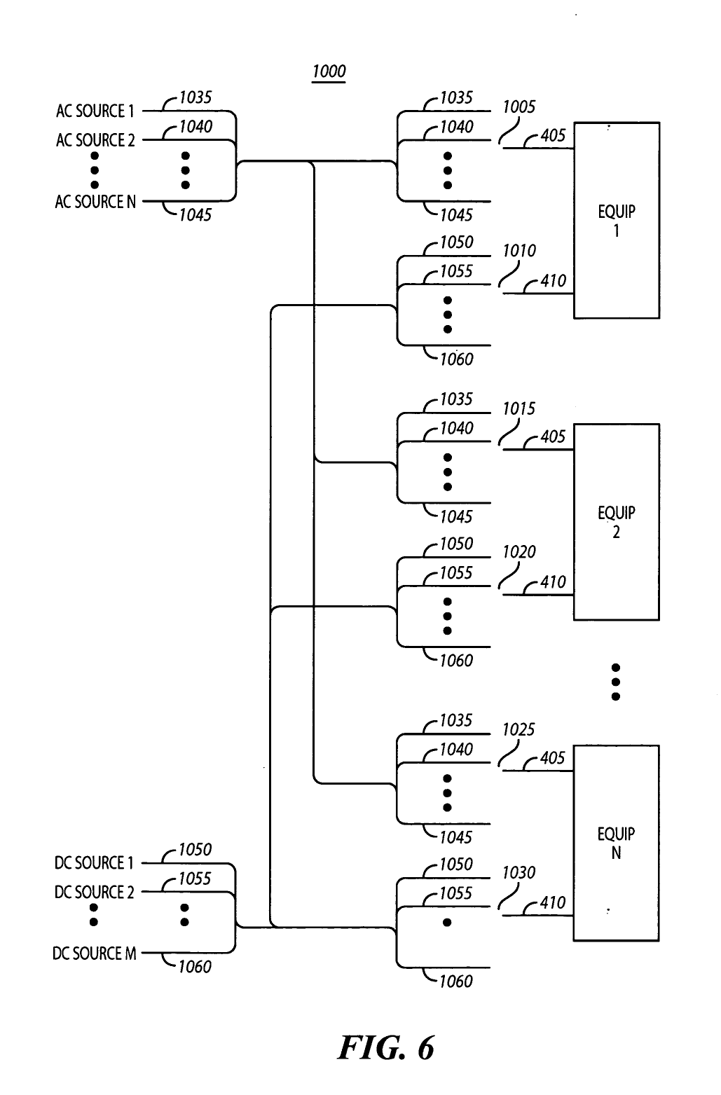

Referring to FIG. 6, a system 1000 operating with multiple AC/DC powered equipments and multiple AC and multiple DC power sources is presented. AC power sources 1035, 1040 . . . 1045 may be any sort of AC source such as single phase or 3-phase, any voltage such as 110 or 220 VAC, and any number of wires, as described previously. These AC sources are selectively routed to AC source inputs 405 of equipments 1, 2 . . . N as required by system requirements. In other words, AC source input 405 of each equipment may be connected to any of the AC sources 1035, 1040 . . . 1045. As an example, constituent parts of the total system may be in various physical locations and the source of AC feeds to these separated equipments may be different. Schematically 1005, 1015 . . . 1025 are decision points at which a specific AC source 1035, 1040 . . . 1045 is connected to a specific equipment 1, 2 . . . N. Any AC source may be connected to any equipment AC source input. DC power sources 1050, 1055 . . . 1060 may be any sort of DC source such as +48, −48, +5 VDC as described previously. These DC sources are selectively routed to DC source inputs 410 of equipments 1, 2 . . . N as required by system requirements. In other words, DC source input 410 of each equipment may be connected to any of the DC sources 1050, 1055 . . . 1060. As an example, constituent parts of the total system may be in various physical locations and the source of DC feeds to these separated equipments may be different. Schematically 1010, 1020 . . . 1030 are decision points at which a specific DC source 1050, 1055 . . . 1060 is connected to a specific equipment 1, 2 . . . N. Any DC source may be connected to any equipment DC source input. The system described allows any available AC source to be connected to any AC equipment input, and allows any available DC source to be connected to any DC equipment input. Equipments may be co-located or physically separate depending on requirements.

Those skilled in the art will appreciate that many other circuit and system configurations can be readily devised to accomplish the desired end without departing from the spirit of the present invention.

While the invention has been described in conjunction with specific embodiments, it is evident that many alternatives, modifications, permutations and variations will become apparent to those of ordinary skill in the art in light of the foregoing description. By way of example and not limitation, the overall system may contain any combination of AC/AC, AC/DC, and DC/DC power input equipments without departing from the invention. Many other variations are also possible. Accordingly, it is intended that the present invention embrace all such alternatives, modifications and variations as fall within the scope of the appended claims.

1. An equipment operable to receive and operate on AC and DC input power, comprising:
an AC distribution system which is operable to receive and distribute AC input power;
a DC distribution system which is operable to receive and distribute DC input power;
one or more AC/DC converters operable to receive AC input power from the AC distribution system and to produce one or more first DC outputs;
one or more DC/DC converters operable to receive DC input power from the DC distribution system and to produce one or more second DC outputs; and
an output combining element operable to couple at least one of the one or more first DC outputs and the one or more second DC outputs to a load.

2. The equipment of claim 1, wherein the AC distribution system provides power to converters which provide one or more DC outputs to the equipment.

3. The equipment of claim 1, wherein the DC distribution system provides power to converters which provide one or more DC outputs to the equipment.

4. The equipment of claim 1, wherein the AC distribution system for the AC input power comprises conditioning for the AC input power.

5. The equipment of claim 1, wherein the DC distribution system for the DC input power comprises conditioning for the DC input power.

6. The equipment of claim 1, wherein the output combining element comprises diode combining of one or more of AC/DC, DC/DC, and AC/DC and DC/DC converter outputs.

7. The equipment of claim 1, wherein the output combining element comprises active or passive elements.

8. The equipment of claim 1, wherein the output combining element comprises load sharing between converters.

9. The equipment of claim 1, wherein the output combining element comprises inputs from one or more redundant converters.

10. The equipment of claim 1, wherein the output combining element includes communications with one or more processors internal or external to the output combining element.

11. The equipment of claim 1, wherein the output combining element comprises control signals from one or more converters.

12. The equipment of claim 1, wherein first and second converters of one or more of the AC/DC converters and the DC/DC converters are in communication for purposes of load control.

13. A power system, comprising:
an AC power source;
a DC power source; and
an equipment operable to receive and operate on power from both the AC and DC power sources.

14. The power system of claim 13, wherein the AC power source further comprises a plurality of AC power sources and the DC power source further comprises a plurality of DC power sources.

15. The power system of claim 13, wherein the equipment comprises:
an AC distribution system which is operable to receive and distribute AC input power;
a DC distribution system which is operable to receive and distribute DC input power;
one or more AC/DC converters operable to receive AC input power from the AC distribution system and to produce one or more first DC outputs;
one or more DC/DC converters operable to receive DC input power from the DC distribution system and to produce one or more second DC outputs;
an output combining element operable to couple at least one of the one or more first DC outputs and the one or more second DC outputs to a load.

16. The power system of claim 13, further comprising a plurality of equipments accepting power from both the AC and DC power sources.

17. The power system of claim 13, wherein the AC and DC power sources further comprise conditioning.

18. A method of operating with dual input power sources, comprising:
converting AC input power received by an equipment to one or more first DC converted voltages;
converting DC input power received by the equipment to one or more second DC converted voltages; and
combining the one or more first DC converted voltages and the one or more second DC converted voltages to derive one or more DC equipment voltages.

19. The method of claim 18, wherein said one or more first and second DC converted voltages are a voltage level and the one or more DC equipment voltages are derived from the voltage level.

20. The method of claim 18, wherein said first and second DC converted voltages comprise a first voltage level and a second voltage level and wherein the one or more DC equipment voltages are derived from the first and second voltage levels.

21. The method of claim 18, wherein said first and second DC converted voltages are a plurality of voltage levels and wherein the one or more DC equipment voltages are an equipment voltage level derived from the plurality of voltage levels.

22. The method of claim 18, further comprising prior to converting:
distributing the AC input power received by the equipment; and
distributing the DC input power received by the equipment.

23. A method of operating a system comprising a plurality of equipments operable from multiple input power sources, comprising:
receiving one or more AC input power sources and one or more DC input power sources by the system;
for each equipment of one or more equipments of the plurality of equipments further comprising:
converting AC input power received by the equipment from the one or more AC input power sources to one or more first DC converted voltages;
converting DC input power received by the equipment from the one or more DC input power sources to one or more second DC converted voltages;
combining the one or more first DC converted voltages and the one or more second DC converted voltages to derive one or more DC equipment voltages.

24. The method of claim 23, wherein said one or more first and second DC converted voltages are a voltage level and the one or more DC equipment voltages are derived from the voltage level.

25. The method of claim 23, wherein said first and second DC converted voltages are a first voltage level and a second voltage level and wherein the one or more DC equipment voltages are derived from the first and second voltage levels.

26. The method of claim 23, wherein said first and second DC converted voltages are a plurality of voltage levels and wherein the one or more DC equipment voltages are an equipment voltage level derived from the plurality of voltage levels.

27. The method of claim 23, further comprising prior to converting:
distributing the AC input power received by the equipment; and
distributing the DC input power received by the equipment.

28. An equipment operable to receive and operate on AC and DC input power, comprising:
first means for distributing AC input power received by the equipment;
second means for distributing DC input power received by the equipment;
first means for converting the AC input power received from the first means for distributing to one or more first DC converted voltages;
second means for converting the DC input power received from the second means for distributing to one or more second DC converted voltages;
means for combining the one or more first DC converted voltages and the one or more second DC converted voltages to derive one or more DC equipment voltages.
